(19) United States
(12) Patent Application Publication
(10) Pub. No.: US 2005/0250511 A1
(43) Pub. Date: Nov. 10, 2005

(54) Method for rate control signaling to facilitate UE uplink data transfer

(76) Inventors: Weimin Xiao, Barrington, IL (US); Amitava Ghosh, Buffalo Grove, IL (US); Robert T. Love, Barrington, IL (US); Rapeepat Ratasuk, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/080,691

(22) Filed: Mar. 15, 2005

Related U.S. Application Data
(60) Provisional application No. 60/568,199, filed on May 5, 2004.

(51) Int. Cl. H04Q 7/20

(52) U.S. Cl. 455/453

(57) ABSTRACT

Embodiments described herein address the desire to have a method for uplink rate control signaling that is able to achieve increased sector and user throughput with relatively high uplink spectrum efficiency. Rate control signaling embodiments are disclosed that use two common persistence values (404, 408) to update the allocated portion of RoT margin for each UE device, and thus, reduce the variation of the RoT. In addition, SHO information is used to control the inter-sector/cell interference and improve the sector throughput. In such embodiments, each UE determines (412) the data rate and time to transmit according to these common persistence values, SHO status and buffered data. Throughput comparable to that of time and rate schedulers, which require significantly more signaling and information, can be achieved by some of these embodiments while also exhibiting less sensitivity to delay, speed of the UE, and burstiness of the traffic.

### REFERENCE(S) TO RELATED APPLICATION(S)

The present application claims priority from provisional application Ser. No. 60/568,199, entitled “METHOD FOR RATE CONTROL SIGNALING TO FACILITATE UE UPLINK DATA TRANSFER,” filed May 5, 2004, which is commonly owned and incorporated herein by reference in its entirety.

This application is related to a co-pending application entitled “METHOD FOR ACK/NACK SIGNALING TO FACILITATE UE UPLINK DATA TRANSFER,” filed on even date herewith, assigned to the assignee of the present application, and hereby incorporated by reference.

This application is related to a co-pending application Ser. No. 10/427,361, entitled “ENHANCED UPLINK RATE SELECTION BY A COMMUNICATION DEVICE DURING SOFT HANDOFF,” filed Apr. 30, 2003, which is assigned to the assignee of the present application.

### FIELD OF THE INVENTION

The present invention relates generally to wireless communication systems and, in particular, to rate control signaling to facilitate UE uplink data transfer.

### BACKGROUND OF THE INVENTION

In a Universal Mobile Telecommunications System (UMTS), such as that proposed for the next of the third generation partnership project (3GPP) standards for the UMTS Terrestrial Radio Access Network (UTRAN), such as wideband code division multiple access (WCDMA) or cdma2000 for example, user equipment (UE) such as a mobile station (MS) communicates with any one or more of a plurality of base station subsystems (BSSs) dispersed in a geographic region. Typically, a BSS (known as Node-B in WCDMA) services a coverage area that is divided up into multiple sectors (known as cells in WCDMA). In turn, each sector is serviced by one or more of multiple base transceiver stations (BTSs) included in the BSS. The mobile station is typically a cellular communication device. Each BTS continuously transmits a downlink pilot signal. The MS monitors the pilots and measures the received energy of the pilot symbols.

In a typical cellular system, there are a number of states and channels for communications between the MS and the BSS. For example, in IS95, in the Mobile Station Control on the Traffic State, the BSS communicates with the MS over a Forward Traffic Channel in a forward link and the MS communicates with the BSS over a Reverse Traffic Channel in a reverse link. During a call, the MS must constantly monitor and maintain four sets of pilots. The four sets of pilots are collectively referred to as the Pilot Set and include an Active Set, a Candidate Set, a Neighbor Set, and a Remaining Set, where, although the terminology may differ, the same concepts generally apply to the WCDMA system.

The Active Set includes pilots associated with the Forward Traffic Channel assigned to the MS. This set is active in that the pilots and companion data symbols associated with this set are all actively combined and demodulated by the MS. The Candidate Set includes pilots that are not currently in the Active Set but have been received by the MS with sufficient strength to indicate that an associated Forward Traffic Channel could be successfully demodulated. The Neighbor Set includes pilots that are not currently in the Active Set or Candidate Set but are likely candidates for handoff. The Remaining Set includes all possible pilots in the current system on the current frequency assignment, excluding the pilots in the Neighbor Set, the Candidate Set, and the Active Set.

When the MS is serviced by a first BTS, the MS constantly searches pilot channels of neighboring BTSs for a pilot that is sufficiently stronger than a threshold value. The MS signals this event to the first, serving BTS using a Pilot Strength Measurement Message. As the MS moves from a first sector serviced by a first BTS to a second sector serviced by a second BTS, the communication system promotes certain pilots from the Candidate Set to the Active Set and from the Neighbor Set to the Candidate Set. The serving BTS notifies the MS of the promotions via a Handoff Direction Message. Afterwards, for the MS to commence communication with a new BTS that has been added to the Active Set before terminating communications with an old BTS, a “soft handoff” will occur.

For the reverse link, typically each BTS in the Active Set independently demodulates and decodes each frame or packet received from the MS. It is then up to a switching center or selection distribution unit (SDU) normally located in a Base Station Site Controller (BSC), which is also known as a Radio Network Controller (RNC) in WCDMA terminology, to arbitrate between the each BTS's decoded frames. Such soft handoff operation has multiple advantages. Qualitatively, this feature improves and renders more reliable handoff between BTSs as a user moves from one sector to the adjacent one. Quantitatively soft-handoff improves the capacity/coverage in a cellular system. However, with the increasing amount of demand for data transfer (bandwidth), problems can arise.

Several third generation standards have emerged, which attempt to accommodate the anticipated demands for increasing data rates. At least some of these standards support synchronous communications between the system elements, while at least some of the other standards support asynchronous communications. At least one example of a standard that supports synchronous communications includes cdma2000. At least one example of a standard that supports asynchronous communications includes WCDMA.

While systems supporting synchronous communications can sometimes allow for reduced search times for handover searching and improved availability and reduced time for position location calculations, systems supporting synchronous communications generally require that the base stations be time synchronized. One such common method employed for synchronizing base stations includes the use of global positioning system (GPS) receivers, which are co-located with the base stations that rely upon line of sight transmissions between the base station and one or more satellites located in orbit around the earth. However, because line of sight transmissions are not always possible for base stations that might be located within buildings or tunnels, or base stations that may be located under the ground, sometimes the time synchronization of the base stations is not always readily accommodated.

However, asynchronous transmissions are not without their own set of concerns. For example, the timing of uplink transmissions in an environment supporting MS-autonomous scheduling (whereby a MS may transmit whenever the MS has data in its transmit buffer and all MSs are allowed to transmit as needed) by the individual MSs can be quite sporadic and/or random in nature. While traffic volume is low, the autonomous scheduling of uplink transmissions is less of a concern, because the likelihood of a collision (i.e. overlap) of data being simultaneously transmitted by multiple MSs is also low. Furthermore, in the event of a collision, there are spare radio resources available to accommodate the need for any retransmissions. However, as traffic volume increases, the likelihood of data collisions (overlap) also increases. The need for any retransmissions also correspondingly increases, and the availability of spare radio resources to support the increased amount of retransmissions correspondingly diminish. Consequently, the introduction of explicit scheduling (whereby a MS is directed by the network when to transmit) by a scheduling controller can be beneficial.

However even with explicit scheduling, given the disparity of start and stop times of asynchronous communications and more particularly the disparity in start and stop times relative to the start and stop times of different uplink transmission segments for each of the non-synchronized base stations, gaps and overlaps can still occur. Both data gaps and overlaps represent inefficiencies in the management of radio resources (such as rise over thermal (ROT), a classic and well-known measure of reverse link traffic loading in CDMA systems), which if managed more precisely can lead to more efficient usage of the available radio resources and a reduction in the rise over thermal (ROT).

For example, FIG. 1 is a block diagram of communication system 100 of the prior art. Communication system 100 can be a cdma2000 or a WCDMA system. Communication system 100 includes multiple cells (seven shown), wherein each cell is divided into three sectors (a, b, and c). A BSS 101-107 located in each cell provides communications service to each mobile station located in that cell. Each BSS 101-107 includes multiple BTSs, which BTSs wirelessly interface with the mobile stations located in the sectors of the cell serviced by the BSS. Communication system 100 further includes a radio network controller (RNC) 110 coupled to each BSS and a gateway 112 coupled to the RNC. Gateway 112 provides an interface for communication system 100 with an external network such as a Public Switched Telephone Network (PSTN) or the Internet.

The quality of a communication link between an MS, such as MS 114, and the BSS servicing the MS, such as BSS 101, typically varies over time and movement by the MS. As a result, as the communication link between MS 114 and BSS 101 degrades, communication system 100 provides a soft handoff (SHO) procedure by which MS 114 can be handed off from a first communication link whose quality has degraded to another, higher quality communication link. For example, as depicted in FIG. 1, MS 114, which is serviced by a BTS servicing sector b of cell 1, is in a 3-way soft handoff with sector c of cell 3 and sector a of cell 4. The BTSs associated with the sectors concurrently servicing the MS, that is, the BTSs associated with sectors 1-b, 3-c, and 4-a, are known in the art as the Active Set of the MS.

Referring now to FIG. 2, a soft handoff procedure performed by communication system 100 is illustrated. FIG. 2 is a block diagram of a hierarchical structure of communication system 100. As depicted in FIG. 2, RNC 110 includes an ARQ function 210, a scheduler 212, and a soft handoff (SHO) function 214. FIG. 2 further depicts multiple BTSs 201-207, wherein each BTS provides a wireless interface between a corresponding BSS 101-107 and the MSs located in a sector serviced by the BSS.

When performing a soft handoff, each BTS 201, 203, 204 in the Active Set of the MS 114 receives a transmission from MS 114 over a reverse link of a respective communication channel 221, 223, 224. The Active Set BTSs 201, 203, and 204 are determined by SHO function 214. Upon receiving the transmission from MS 114, each Active Set BTS 201, 203, 204 demodulates and decodes the contents of a received radio frame along with related frame quality information.

At this point, each Active Set BTS 201, 203, 204 then conveys the demodulated and decoded radio frame to RNC 110, along with related frame quality information. RNC 110 receives the demodulated and decoded radio frames along with related frame quality information from each BTS 201, 203, 204 in the Active Set and selects a best frame based on frame quality information. Scheduler 212 and ARO function 210 of RNC 110 then generate control channel information that is distributed as identical pre-formatted radio frames to each BTS 201, 203, 204 in the Active Set. The Active Set BTSs 201, 203, 204 then simulcast the pre-formatted radio frames over the forward link. The control channel information is then used by MS 114 to determine what transmission rate to use.

Alternatively, the BTS of the current cell where the MS is camped (BTS 201) can include its own scheduler and bypass the RNC 110 when providing scheduling information to the MS. In this way, scheduling functions are distributed by allowing a mobile station (MS) to signal control information corresponding to an enhanced reverse link transmission to active set base transceiver stations (BTSs) and by allowing the BTSs to perform control functions that were previously supported by a RNC. The MS in a SHO region can choose a scheduling assignment corresponding to a best Transport Format and Resource Indicator (TFRI) out of multiple scheduling assignments that the MS receives from multiple Active Set BTS. As a result, the enhanced uplink channel can be scheduled during SHO, without any explicit communication between the BTSs. In either case, explicit transmit power constraints (which are implicit data rate constraints) are provided by a scheduler, which are used by the MS 114, along with control channel information, to determine what transmission rate to use.

As proposed for the UMTS system, a MS can use an enhanced uplink dedicated transport channel (EUDCH) to achieve an increased uplink data rate. The MS must determine the data rate to use for the enhanced uplink based on local measurements at the MS and information provided by the scheduler and must do so during soft handoff such that the interference level increase at adjacent cells (other than Active Set cells) is not so large that uplink voice and other signaling coverage is significantly reduced.

Two fundamental approaches that exist in scheduling UE transmissions for the EUDCH: (1) Node B controlled rate scheduling, where all uplink transmissions can randomly occur in parallel with the selected rates restricted to keep the total noise rise at the Node B at an acceptable level, and (2) Node B controlled time and rate scheduling, where only a subset of UE that have traffic to send are selected to transmit over a given time interval also with selected rates restricted to meet noise rise requirements.

To achieve high uplink spectrum efficiency while satisfying the Rise-over-Thermal (RoT) noise requirements at a Node B, tight control of the variation of the RoT and the inter-sector/cell interference is important but quite difficult. By moving the scheduler from the RNC to the Node-Bs, most information concerning the inter-sector/cell interference is lost. This is a significant drawback since over 50% of the RoT is from the inter-sector/cell contribution, which is a waste of the resource of the RoT margin. In addition, controlling the RoT becomes more difficult with moderate/high speed UE, bursty traffics and long delay (frame size). Using existing approaches, the RoT variation is relatively large and inter-cell/sector interference is not well-controlled, resulting in relatively low sector and user throughput. Accordingly, it would be highly desirable to have a method for uplink rate control signaling that is able to achieve increased sector and user throughput with relatively high uplink spectrum efficiency in spite of these difficulties.

### BRIEF DESCRIPTION OF THE DRAWINGS

FIG. 1 is a block diagram of an exemplary communication system of the prior art.

FIG. 2 is a block diagram of a hierarchical structure of the communication system of FIG. 1.

FIG. 3 depicts a distributed network architecture in accordance with multiple embodiments of the present invention.

FIG. 4 is a logic flow diagram of uplink rate control signaling in accordance with multiple embodiments of the present invention.

FIG. 5 is a block diagram of a communication system in accordance with multiple embodiments of the present invention.

FIG. 6 is an exemplary illustration of SAM code channel sets, in which scheduled users are assigned to SAM channel in scheduled user set or poor coverage/non-scheduled SHO user set and in which non-scheduled SHO users can only be assigned SAM channels in the non-scheduled SHO user set, in accordance with multiple embodiments of the present invention.

FIG. 7 is an exemplary illustration of SAM code channel sets, given that SHO users can only be EU scheduled by one active set cell (same cell that is scheduling HS-PDSCH) until active set cell reselection occurs, in accordance with multiple embodiments of the present invention.

FIG. 8 is an exemplary illustration of a Scheduling Assignment Message channel in accordance with multiple embodiments of the present invention.

FIG. 9 is an exemplary illustration of SAM masking (color coding), encoding, and puncturing in accordance with multiple embodiments of the present invention.

FIG. 10 is an exemplary illustration of a FPCCH and a SPCCH in accordance with multiple embodiments of the present invention.

FIG. 11 is a table displaying exemplary characteristics of enhanced uplink channels in accordance with multiple embodiments of the present invention.

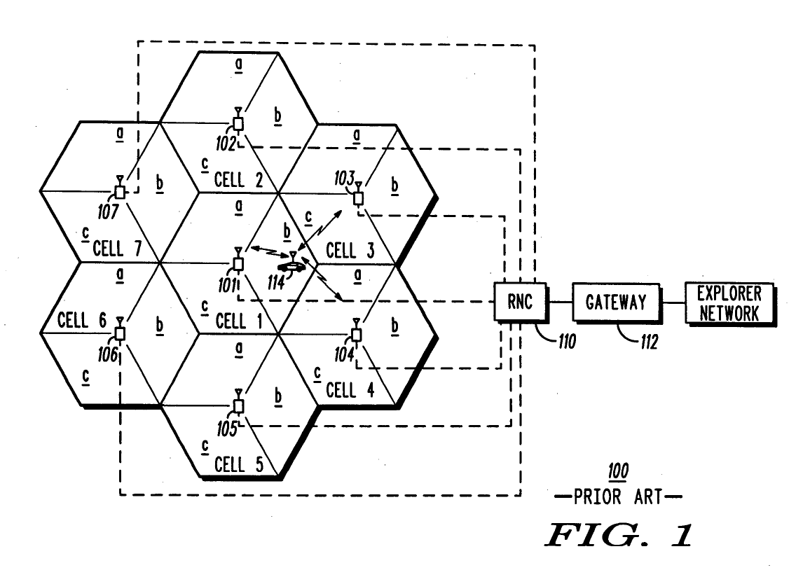

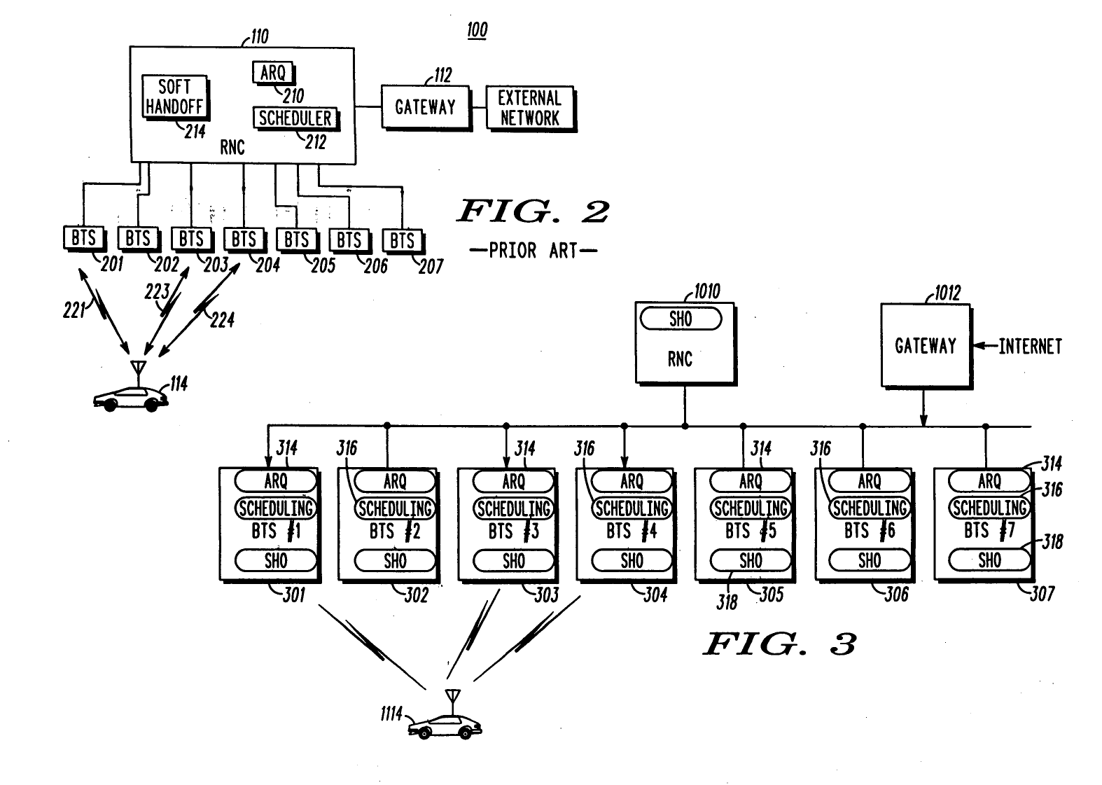

### DETAILED DESCRIPTION OF EMBODIMENTS

Embodiments described herein address the desire to have a method for uplink rate control signaling that is able to achieve increased sector and user throughput with relatively high uplink spectrum efficiency. Rate control signaling embodiments are disclosed that use two common persistence values to update the allocated portion of RoT margin for each UE device, and thus, reduce the variation of the RoT. In addition, SHO information is used to control the inter-sector/cell interference and improve the sector throughput. In such embodiments, each UE determines the data rate and time to transmit according to these common persistence values, SHO status and buffered data. Throughput comparable to that of time and rate schedulers, which require significantly more signaling and information, can be achieved by some of these embodiments while also exhibiting less sensitivity to delay, speed of the UE, and burstiness of the traffic.

In some specific embodiments of the present invention, a Node-B sends two sets of persistence information to all the UE devices to control the rate of the UE. Each UE decides the data rate and time to transmit according to one or more of these persistence values, its power margin, buffer occupancy and SHO status. Significantly less signaling is needed through the use of common signaling instead of dedicated signaling to each UE. A slow persistence value is sent infrequently (1 Hz, e.g.) and reports the average load/status of the sector. This slow persistence value may be sent using a secondary common control channel (S-CCPCH). The Node-B measures the average total load/status of the sector and sends associated slowly-updated signaling to control each UE's portion of the RoT margin and hence its transmitted data rate. The infrequent update reduces system complexity and allows the information to be transmitted reliably at low power through, for example, the use of repetitions.

In addition, in some specific embodiments, a fast persistence which is proportional to the instantaneous RoT level of the sector is reported every TTI (e.g., at 50 Hz) using a new Fast Persistence Common Control Channel (FPCCH). The FPCCH carries a single (global) up/down bit based on instantaneous RoT cell measurements. The up/down persistence bit is sent to all UE devices served by the cell every 2 ms (for example) in order to control RoT variation and the inter-sector/cell interference. By using this fast adjustment of the effective RoT margin, a relatively small variation of the RoT can be achieved, translating into high sector/user throughput. Additionally, a scheduling algorithm may utilize SHO information to reduce the inter-sector/cell interference contribution to RoT margin, which in turn also improves the sector/user throughput.

Embodiments of the present invention encompass a method for rate control signaling to facilitate uplink data transfer by user equipment (UE) in a wireless communication system. The method comprises periodically determining a rise over thermal (RoT) level and transmitting, by a Node-B to UE, an indication of the RoT level via a first common control channel. The method also comprises periodically determining an aggregate mean loading value and transmitting, by the Node-B to the UE, an indication of the aggregate mean loading value via a second common control channel.

Embodiments of the present invention encompass another method for rate control signaling. This method comprises periodically receiving, by UE, an indication of a rise over thermal (RoT) level via a first common control channel of a Node-B and periodically receiving, by the UE, an indication of an aggregate mean loading value via a second common control channel of the Node-B. The method also comprises determining, by the UE, a Modulation and Coding Scheme (MCS) level using the RoT level and the aggregate mean loading value and transmitting, by the UE, uplink data at the MCS level.

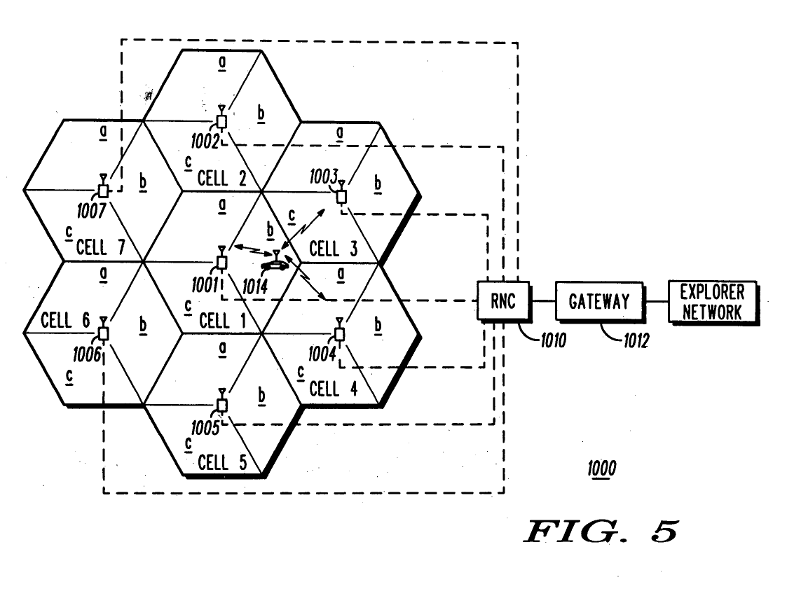

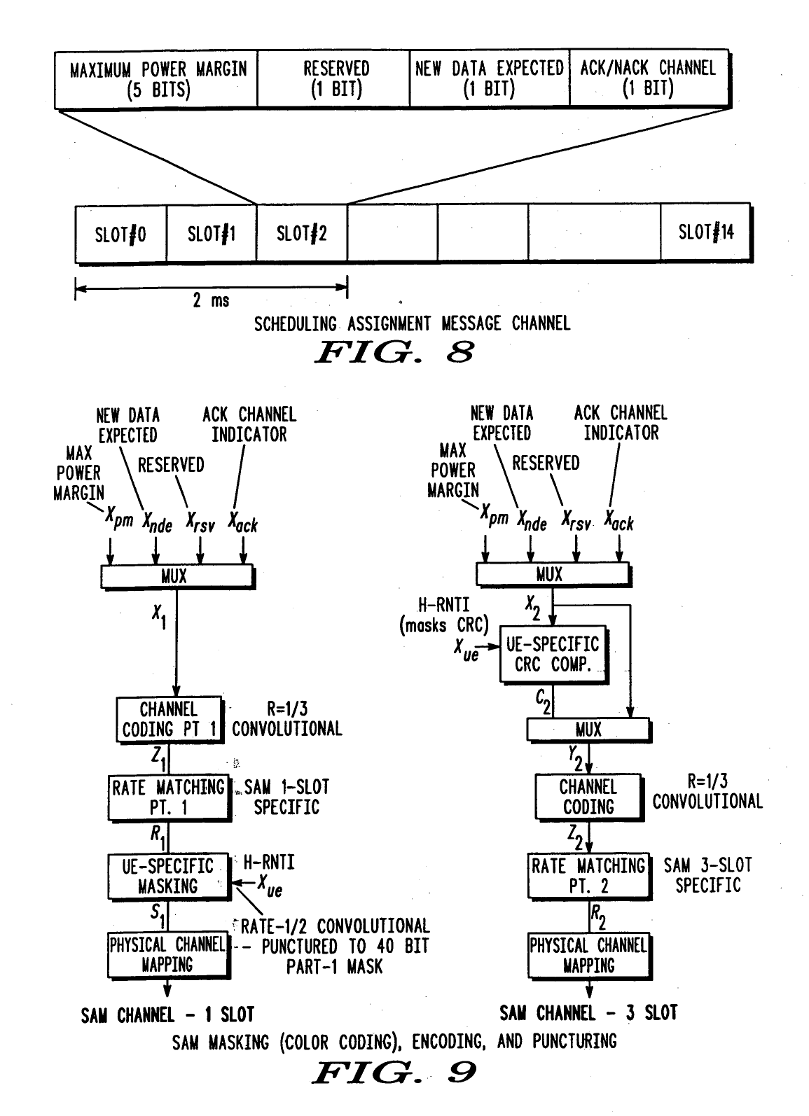

These and other embodiments of the present invention may be more fully described with reference to FIGS. 3-11. FIG. 5 is a block diagram of a communication system 1000 in accordance with multiple embodiments of the present invention. Preferably, communication system 1000 is a Code Division Multiple Access (CDMA) communication system, such as cdma2000 or Wideband CDMA (WCDMA) communication system, that includes multiple communication channels. Those who are of ordinary skill in the art realize that communication system 1000 may operate in accordance with any one of a variety of wireless communication systems, such as a Global System for Mobile communication (GSM) communication system, a Time Division Multiple Access (TDMA) communication system, a Frequency Division Multiple Access (FDMA) communication system, or an Orthogonal Frequency Division Multiple Access (OFDM) communication system.

Similar to communication system 100, communication system 1000 includes multiple cells (seven shown). Each cell is divided into multiple sectors (three shown for each cell—sectors a, b, and c). A base station subsystem (BSS) 1001-1007 located in each cell provides communications service to each mobile station located in that cell. Each BSS 1001-1007 includes multiple base stations, also referred to herein as base transceiver stations (BTSs), which wirelessly interface with the mobile stations located in the sectors of the cell serviced by the BSS. Communication system 1000 further includes a radio network controller (RNC) 1010 coupled to each BSS, preferably through a 3GPP TSG UTRAN lub Interface, and a gateway 1012 coupled to the RNC. Gateway 1012 provides an interface for communication system 1000 with an external network such as a Public Switched Telephone Network (PSTN) or the Internet.

Referring now to FIGS. 3 and 5, communication system 1000 further includes at least one mobile station (MS) 1014. MS 1014 may be any type of wireless user equipment (UE), such as a cellular telephone, a portable telephone, a radiotelephone, or a wireless modem associated with data terminal equipment (DTE) such as a personal computer (PC) or a laptop computer. Note that MS, UE, and user are used interchangeably throughout the following text. MS 1014 is serviced by multiple base stations, or BTSs, that are included in an Active Set associated with the MS. MS 1014 wirelessly communicates with each BTS in communication system 1000 via an air interface that includes a forward link (from the BTS to the MS) and a reverse link (from the MS to the BTS). Each forward link includes multiple forward link control channels, a paging channel, and traffic channel. Each reverse link includes multiple reverse link control channels, a paging channel, and a traffic channel. However, unlike communication system 100 of the prior art, each reverse link of communication system 1000 further includes another traffic channel, an Enhanced Uplink Dedicated Transport Channel (EUDCH), that facilitates high speed data transport by permitting a transmission of data that can be dynamically modulated and coded, and demodulated and decoded, on a sub-frame by sub-frame basis.

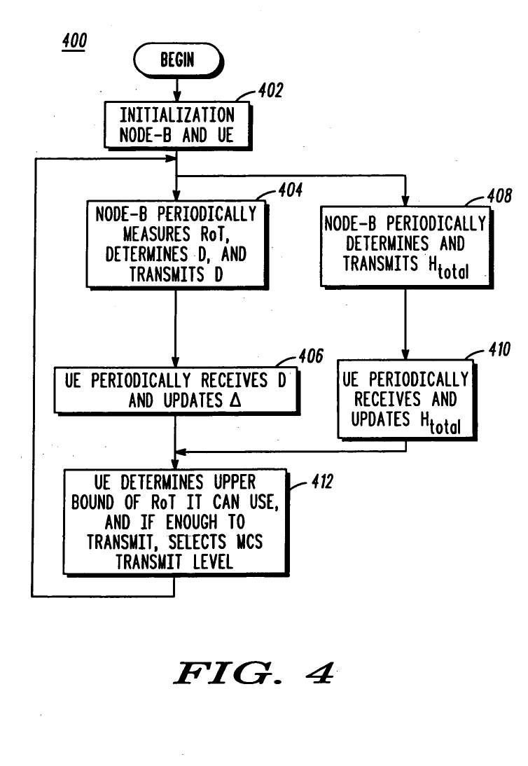

Communication system 1000 includes a soft handoff (SHO) procedure by which MS 1014 can be handed off from a first air interface whose quality has degraded to another, higher quality air interface. For example, as depicted in FIG. 4, MS 1014, which is serviced by a BTS servicing sector b of cell 1, is in a 3-way soft handoff with sector c of cell 3 and sector a of cell 4. The BTSs associated with the sectors concurrently servicing the MS, that is, the BTSs associated with sectors 1-b, 3-c, and 4-a, are the Active Set of the MS. In other words, MS 1014 is in soft handoff (SHO) with the BTSs 301, 303, and 304, associated with the sectors 1-b, 3-c, and 4-a servicing the MS, which BTSs are the Active Set of the MS. As used herein, the terms ‘Active Set’ and ‘serving,’ such as an Active Set BTS and a serving BTS, are interchangeable—and both refer to a BTS that is in an Active Set of an associated MS. Furthermore, although FIGS. 3 and 4 depict BTSs 301, 303, and 304 as servicing only a single MS, those who are of ordinary skill in the art realize that each BTS 301-307 may concurrently schedule, and service, multiple MSs, that is, each BTS 301-307 may concurrently be a member of multiple Active Sets.

FIG. 3 depicts a network architecture 300 of communication system 1000 in accordance with multiple embodiments of the present invention. As depicted in FIG. 3, communication system 1000 includes multiple BTSs 301-307, wherein each BTS provides a wireless interface between a corresponding BSS 1001-1007 and the MSs located in a sector serviced by the BTS. Preferably, a scheduling function 316, an ARQ function 314 and a SHO function 318 are distributed in each of the BTSs 301-307. RNC 1010 is responsible for managing mobility by defining the members of the Active Set of each MS serviced by communication system 1000, such as MS 1014, and for coordinating multicast/multireceive groups. For each MS in communication system 1000, Internet Protocol (IP) packets are multi-cast directly to each BTS in the Active Set of the MS, that is, to BTSs 301, 303, 304 in the Active Set of MS 1014.

Preferably, each BTS 301-307 of communication system 1000 includes a SHO function 318 that performs at least a portion of the SHO functions. For example, SHO function 318 of each BTS 301, 303, 304 in the Active Set of the MS 1014 performs SHO functions such as frame selection and signaling of a new data indicator. Each BTS 301-307 can include a scheduler, or scheduling function, 316 that alternatively can reside in the RNC 110. With BTS scheduling, each Active Set BTS, such as BTSs 301, 303, and 304 with respect to MS 1014, can choose to schedule the associated MS 1014 without need for communication to other Active Set BTSs based on scheduling information signaled by the MS to the BTS and local interference and SNR information measured at the BTS. By distributing scheduling functions 306 to the BTSs 301-307, there is no need for Active Set handoffs of a EUDCH in communication system 1000. The ARQ function 314 and AMC function, which functionality also resides in RNC 110 of communication system 100, can also be distributed in BTSs 301-307 in communication system 1000. As a result, when a data block transmitted on a specific Hybrid ARQ channel has successfully been decoded by an Active Set BTS, the BTS acknowledges the successful decoding by conveying an ACK to the source MS (e.g. MS 1014) without waiting to be instructed to send the ACK by the RNC 1010.

In order to allow each Active Set BTS 301, 303, 304 to decode each EUDCH frame, MS 1014 conveys to each Active Set BTS, in association with the EUDCH frame, modulation and coding information, incremental redundancy version information, HARQ status information, and transport block size information from MS 1014, which information is collectively referred to as transport format and resource-related information (TFRI). The TFRI only defines rate and modulation coding information and H-ARQ status. The MS 1014 codes the TFRI and sends the TFRI over the same frame interval as the EUDCH (accounting for the fact that the frame boundaries of the TFRI and EUDCH may be staggered). By providing MS 1014 signaling of the TFRI corresponding to each enhanced reverse link transmission to the Active Set BTSs 301, 303, 304, the communication system 1000 can support HARQ, AMC, Active Set handoff, and scheduling functions in a distributed fashion.

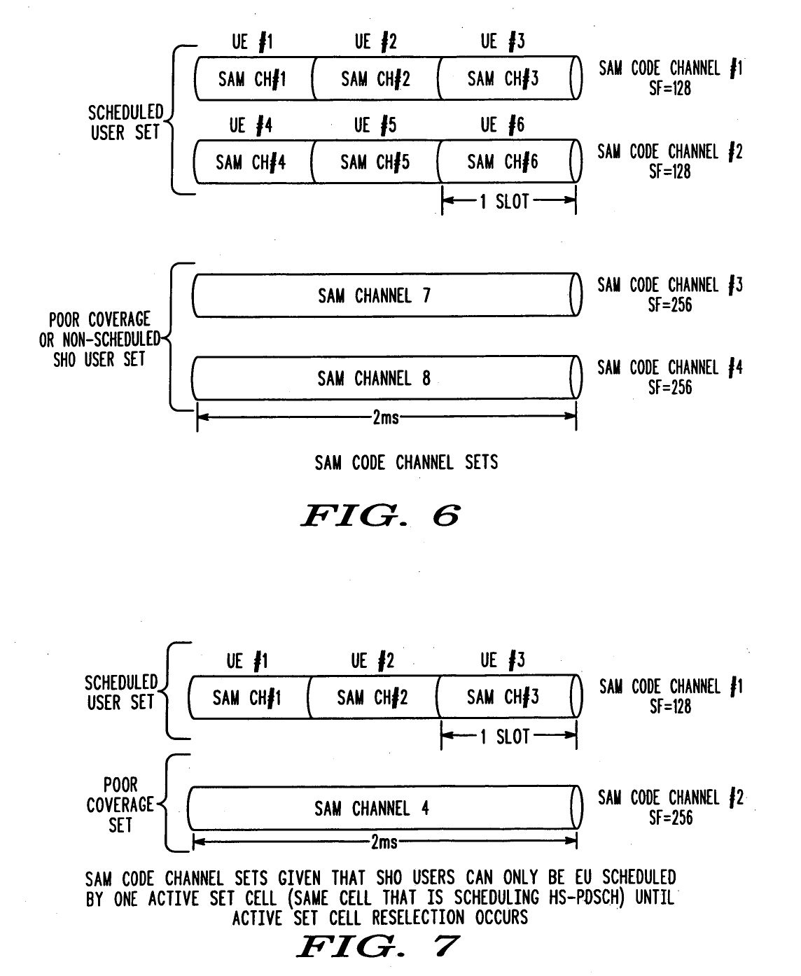

To provide some additional context, FIGS. 6-9 provide exemplary illustrations of a Scheduling Assignment Message (SAM) and SAM code channels. The SAM may be used to schedule the starting time of an individual UE's E-DPDCH (or DPDCH) transmission and indicate the maximum allowed power margin (or maximum TFC). A unique UE ID is used for color coding each SAM channel to allow a user to detect its assigned SAM channel.

In some embodiments, convolutional coding, color coding and OVSF coding with spreading factor (SF) of 128 or 256 is used for the SAM channel with 1 and 3 slot TTI. This allows significant reliability with low power operation and efficient code space utilization. The start time of the SAM channel is time aligned with the start time of the HS-SCCH. For scheduled users it is proposed that 8 information bits and 12 CRC bits be mapped to 40 binary symbols using Rate=½ convolutional coding followed by color coding (using the same 40-bit UE-specific mask applied to Part-1 of the HS-SCCH generated from the 16-bit HS-DSCH Radio Network Identifier (H-RNTI)) and then spread with a SF=128 OVSF code over a single slot. For non-scheduled SHO users it is proposed that 8 information bits, 6 tail and 16 CRC bits are R=⅓ convolutional-encoded and rate matched to 60 binary symbols are modulation mapped with the CRC masked with the 16-bit H-RNTI (color coding). The symbols are then spread with a SF=256 OVSF code over the three slots of a 2 ms TTI.

Given the above, the processing gain can therefore be computed:
1 slot: PG=10*log10(2560/8)=25.1 dB
3 slot: PG=10*log10((3*2560)/8)=29.2 dB

Given the 0.1% BER Eb/Nt=4.0 dB for an AWGN channel then:
Ec/Ior_{—}1slot=−21.1 dB for 0 dB Geometry (=4.0−25.1−(+0))
Ec/Ior_{—}3slot=−20.8 dB for −5 dB Geometry (=4.0−29.8−(−5))

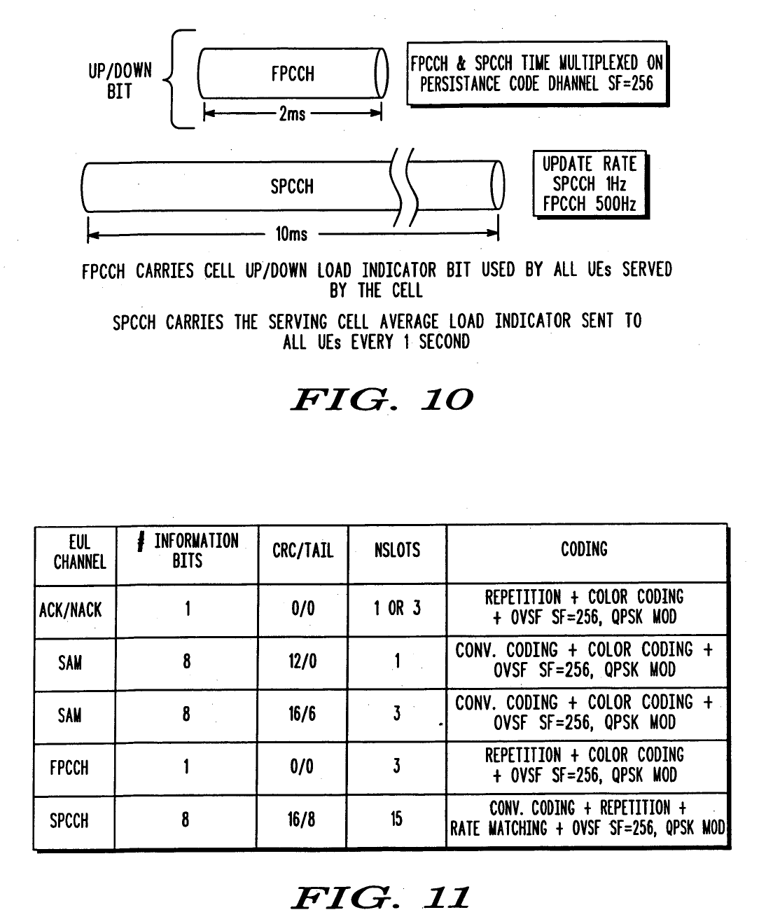

In embodiments of the present invention, two additional downlink control channels are also used. As depicted in FIG. 10 and detailed in FIG. 11, a Fast Persistence common control channel (FPCCH) carries a single (global) up/down bit based on instantaneous RoT cell measurements. The up/down persistence bit is sent to all UE served by the cell every 2 ms in order to control RoT variation. (Note the same up/down bit is used by all UE). A Slow Persistence common control channel (SPCCH) updates all UE with the serving cell's average load status (8-bits) once per second (1 Hz update rate) such that each UE adjusts its allotted RoT margin thus controlling its transmitted data rate.

On the FPCCH, a single up/down bit is repeated 60 times followed by modulation mapping and then spread with OVSF code of spreading factor (SF) 256 over the three slots of a 2 ms TTI. Therefore, the processing gain can be computed:
PG=10*log10(3*2560)=38.9 dB
Given the 1% BER Eb/Nt=4.5 dB for BPSK over an AWGN channel then:
Ec/Ior FPCCH=−29.4 dB for −5 dB Geometry (=4.5−38.9−(−5))

On the SPCCH, an 8-bit cell load indicator, 16-bit CRC, and 8-bit tail are R= 1/3 convolutional encoded and rate matched to 300 binary symbols, QPSK modulation mapped and then spread with a SF=256 OVSF code over fifteen slots of a 10 ms TTI. Note that the SPCCH is time multiplexed on the same persistence code channel as the FPCCH Channel without system impact since the SPCCH transmission is only sent once per second.

Given the above, the processing gain can therefore be computed:
PG=10*log10(38400/8)=36.8 dB

Given the 0.1% BER Eb/Nt=4.0 dB for an AWGN channel then:
Ec/Ior SPCCH=−27.8 dB for −5 dB Geometry (=4.0−36.8−(−5))

FIG. 4 is a logic flow diagram of uplink rate control signaling in accordance with multiple embodiments of the present invention. Diagram 400 depicts an exemplary rate control algorithm to which various alternative embodiments exist in accordance with the present invention. The logic flow begins with initialization (402). Assuming there are K active UE devices in a sector, the Node-B and UE devices initialize as follows:

$$D = 0 , Δ = 0.5 , {H}_{total} = \frac{1}{Δ} {\sum }_{active} \frac{{H}_{k}}{{L}_{SHO}}$$

where L_{SHO} is equal to 1 if the UE is not in SHO, 2 if in 2-way SHO, and 3 if in 3-way SHO, etc., and Hₖ=F(hₖ, L_{buf, k}, wₖ) is a function of the channel quality hₖ (uplink or downlink), buffer occupancy L_{buf, k,} weighting factor wₖ from traffic model priority or QoS, etc. It is assumed that this information is available at both the Node-B and the UE devices and the parameters k and Hₖ are updated in the same manner at both Node-B and UE k. Here the channel quality of uplink may be estimated from pilot or power control information while the channel quality of the downlink is obtained from the HSDPA CQI feedback of the UE. Note that only one of them is needed.

The Node-B measures (404) the instantaneous received RoT over a TTI time (e.g., 2 or 10 ms) and then computes D as follows:

$$D = \{ \begin{matrix}- 1 , & if RoT > U \\ 1 , & if RoT < L \\ 0 , & otherwise\end{matrix}$$

Here, U and L are some predetermined thresholds. Node-B transmits the fast persistence parameter D every TTI using a common control channel, such as a FPCCH or time multiplexed over the common ACK/NACK channel, for example.

Each UE device receives (406) the fast persistence parameter D and updates Δ (n) according to:

$$Δ ( n ) = max \{ min \{ Δ ( n - 1 ) \times {10}^{\frac{D ( n ) δ}{10}} , {Δ}_{max} \} , {Δ}_{min} \}$$

where δ is a small step size, say 0.01 dB, for example.

The Node-B and UE k also update Hₖ periodically according to Hₖ(n)=λHₖ(n−1)+(1−λ)F(hₖ, L_{buf, k}, wₖ). The slow persistence parameter, Hₜₒₜₐₗ is then determined (408) at the Node-B according to

$${H}_{total} = \frac{1}{Δ ( n )} {\sum }_{active} \frac{{H}_{k}}{{L}_{SHO}}$$

and an indication of Hₜₒₜₐₗ is transmitted (once per second, for example) using a common control channel, such as a secondary common control channel (S-CCPCH). Each UE device receives (410) the Hₜₒₜₐₗ parameter, it updates its copy and resets Δ(n)=1. Note that generally in SHO, a UE device gets persistence information from the strongest downlink active set cell and scales down maximum rate based on its SHO state.

To prevent a UE device from transmitting when the channel is bad, the parameter R_{margin}^{k}(n) gives an upper-bound of the RoT that the UE can use. Thus, when the channel is bad, the UE won't transmit at high power contributing a lot of interference into the network while achieving little user/sector throughput. Also, Rₘᵢₙ^{k}(n) provides a lower-bound of RoT, corresponding to a minimum data-rate, that a UE device should use when the channel conditions are bad. Each active UE determines (412) its portion of the RoT margin according to:

$${R}_{margin}^{k} ( n ) = \frac{RoT \times {H}_{k}}{{H}_{total} {L}_{SHO , k}} \times Δ ( n )$$

The UE then uses its RoT margin, its instantaneous uplink channel quality (or the TFCS state machine as in Rel-99) and its data in the buffer to decide the MCS for transmission, which includes the data rate, code-rate, modulation and power.

A more detailed example of how MCS levels for enhanced uplink might be determined follows. To reduce the overhead for control channel signaling, the TFRI channel which includes transport block size, modulation, coding and new data indicator is limited to 8 bits. Out of the 8 bits, 5 bits are used for communicating the transport block size, modulation and coding rates (See Enhanced Uplink TR25.986 V2.0.0, R1-040392). The redundancy version (RV) is computed implicitly by deriving the parameters from the connection frame number (CFN) (See R1-04207, “Feasibility of IR schemes for EUL during SHO”, Siemens) and as such no additional bits are required to signal the RV parameters. An N-channel fully synchronous stop-and-wait protocol is assumed when deriving the number of bits required for the TFRI channel. Table-1 proposes a set of 31 MCS levels which can be signaled using 5 bits. There is room for 5 more additional MCS levels to be added to this table.

TABLE 1
MCS Levels

| Data | | | | | | | | | | |
|---|---|---|---|---|---|---|---|---|---|---|
| Rate | 2 ms Tr | | | Symbols | Data Rate | Code Rate | Data Rate | Code Rate | Data Rate | Code Rate |
| (Kbps) | Blk (bits) | SF | Mod | in 2 ms | 1^{st} Tx | 1^{st} Tx | 2^{nd} Tx | 2^{nd} Tx | 3^{rd} Tx | 3^{rd} Tx |
| 8 | 16 | 256 | BPSK | 30 | 8 | 0.53 | 4 | 0.33 | 2.67 | 0.33 |
| 16 | 32 | 128 | BPSK | 60 | 16 | 0.53 | 8 | 0.33 | 5.33 | 0.33 |
| 32 | 64 | 64 | BPSK | 120 | 32 | 0.53 | 16 | 0.33 | 10.7 | 0.33 |
| 40 | 80 | 32 | BPSK | 240 | 40 | 0.33 | 20 | 0.33 | 13.3 | 0.33 |
| 64 | 128 | 32 | BPSK | 240 | 64 | 0.53 | 32 | 0.33 | 21.3 | 0.33 |
| 80 | 160 | 16 | BPSK | 480 | 80 | 0.33 | 40 | 0.33 | 26.7 | 0.33 |
| 96 | 192 | 16 | BPSK | 480 | 96 | 0.40 | 48 | 0.33 | 32 | 0.33 |
| 128 | 256 | 16 | BPSK | 480 | 128 | 0.53 | 64 | 0.33 | 42.7 | 0.33 |
| 160 | 320 | 8 | BPSK | 960 | 160 | 0.33 | 80 | 0.33 | 53.3 | 0.33 |
| 192 | 384 | 8 | BPSK | 960 | 192 | 0.40 | 96 | 0.33 | 64 | 0.33 |
| 256 | 512 | 8 | BPSK | 960 | 256 | 0.53 | 128 | 0.33 | 85.3 | 0.33 |
| 320 | 640 | 4 | BPSK | 1920 | 320 | 0.33 | 160 | 0.33 | 107 | 0.33 |
| 384 | 768 | 4 | BPSK | 1920 | 384 | 0.40 | 192 | 0.33 | 128 | 0.33 |
| 640 | 1280 | 4 | QPSK | 1920 | 640 | 0.33 | 320 | 0.33 | 213 | 0.33 |
| 768 | 1536 | 4 | QPSK | 1920 | 768 | 0.40 | 384 | 0.33 | 256 | 0.33 |
| 960 | 1920 | 4 | QPSK | 1920 | 960 | 0.50 | 480 | 0.33 | 320 | 0.33 |
| 1152 | 2304 | 4 | QPSK | 1920 | 1152 | 0.60 | 576 | 0.33 | 384 | 0.33 |
| 1280 | 2560 | 2 | QPSK | 3840 | 1280 | 0.333 | 640 | 0.33 | 427 | 0.33 |
| 1440 | 2880 | 2 | QPSK | 3840 | 1440 | 0.375 | 720 | 0.33 | 480 | 0.33 |
| 1728 | 3456 | 2 | QPSK | 3840 | 1728 | 0.450 | 864 | 0.33 | 576 | 0.33 |
| 1920 | 3840 | 2 | QPSK | 3840 | 1920 | 0.500 | 960 | 0.33 | 640 | 0.33 |
| 2160 | 4320 | 2 | QPSK | 3840 | 2160 | 0.563 | 1080 | 0.33 | 720 | 0.33 |
| 2160 | 4320 | 2, 4 | QPSK | 5760 | 2160 | 0.375 | 1080 | 0.33 | 720 | 0.33 |
| 2496 | 4992 | 2, 4 | QPSK | 5760 | 2496 | 0.433 | 1248 | 0.33 | 832 | 0.33 |
| 2880 | 5760 | 2, 4 | QPSK | 5760 | 2880 | 0.500 | 1440 | 0.33 | 960 | 0.33 |
| 3200 | 6400 | 2, 4 | QPSK | 5760 | 3200 | 0.556 | 1600 | 0.33 | 1067 | 0.33 |
| 3649 | 7298 | 2, 4 | QPSK | 5760 | 3649 | 0.634 | 1824.5 | 0.33 | 1216 | 0.33 |
| 4096 | 8192 | 2, 4 | QPSK | 5760 | 4096 | 0.711 | 2048 | 0.356 | 1365 | 0.33 |
| 4322 | 8644 | 2, 4 | QPSK | 5760 | 4322 | 0.750 | 2161 | 0.375 | 1441 | 0.33 |
| 5124 | 10248 | 2, 4 | QPSK | 5760 | 5124 | 0.890 | 2562 | 0.445 | 1708 | 0.33 |
| 5760 | 11520 | 2, 4 | QPSK | 5760 | 5760 | 1.000 | 2880 | 0.500 | 1920 | 0.33 |
| TBD | | | | | | | | | | |

For reliable and simplified signaling an N-channel fully synchronous or synchronous stop-and-wait protocol is desired for Enhanced Uplink. Similar to HS-DSCH, a two-stage rate-matching scheme can be used for Enhanced Uplink. The RV parameters (s and r) are fixed for each transmission and can be tied to the instance of the N-channel stop-and-wait protocol, new data indicator state, and SFN/CFN as shown in Table 2. From Table 1, it may be observed that the systematic bits wraps around on the 3^{rd} transmission in most of the cases.

Table 3 shows an example of s and r for each transmission.

To support Incremental Redundancy in SHO the reliability of the new data indicator bit needs to be improved significantly with the above scheme (See R1-04207, “Feasibility of IR schemes for EUL during SHO”, Siemens). As an alternative, only Chase combining may be supported in SHO so that the RV parameters are independent of the new data indicator bit. One other alternative for IR transmission is to tie the s and r parameters to CFN only as shown in the last column of

Table 3. It may be noted that while high reliability is achieved in this case, the first transmission may not be self-decodable under some circumstances.

TABLE 2
Relation between CFN, HARQ Channel#,
New Data Indicator and RV (N = 6)

| | | | | | IR: s and r |
|---|---|---|---|---|---|
| | HARQ | New Data | | Chase: s | (Tied to |
| CFN | Channel# | Indicator | IR: s and r | and r | CFN) |
| 0 | 0 | 0 | (1, 0) | (1, 0) | (1, 0) |
| 1 | 1 | 0 | (1, 0) | (1, 0) | (1, 0) |
| 2 | 2 | 0 | (1, 0) | (1, 0) | (1, 0) |
| 3 | 3 | 0 | (1, 0) | (1, 0) | (1, 0) |
| 4 | 4 | 0 | (1, 0) | (1, 0) | (1, 0) |
| 5 | 5 | 0 | (1, 0) | (1, 0) | (1, 0) |
| 6 | 0 | 1 | (1, 0) | (1, 0) | (0, 1) |
| 7 | 1 | 0 | (0, 1) | (1, 0) | (0, 1) |
| 8 | 2 | 0 | (0, 1) | (1, 0) | (0, 1) |
| 9 | 3 | 0 | (0, 1) | (1, 0) | (0, 1) |
| 10 | 4 | 1 | (1, 0) | (1, 0) | (0, 1) |
| 11 | 5 | 1 | (1, 0) | (1, 0) | (0, 1) |
| 12 | 0 | 2 | (1, 0) | (1, 0) | (0, 2) |
| 13 | 1 | 0 | (0, 2) | (1, 0) | (0, 2) |
| 14 | 2 | 1 | (1, 0) | (1, 0) | (0, 2) |
| 15 | 3 | 0 | (0, 2) | (1, 0) | (0, 2) |
| 16 | 4 | 1 | (1, 0) | (1, 0) | (0, 2) |
| 17 | 5 | 1 | (0, 1) | (1, 0) | (0, 2) |

(Note:
some channel instances will be skipped when table wrap around occurs depending on N)

TABLE 3
RV Parameters at each Tx

| | | |
|---|---|---|
| 1^{st} Transmission | 2^{nd} Transmission | 3^{rd} Transmission |

| s | R | s | r | s | r |
|---|---|---|---|---|---|
| 1 | 0 | 0 | 1 | 0 | 2 |

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

1. A method for rate control signaling to facilitate user equipment (UE) uplink data transfer, the method comprising:
periodically determining a rise over thermal (RoT) level;
periodically transmitting, by a Node-B to UE, an indication of the RoT level via a first common control channel;
periodically determining an aggregate mean loading value;
periodically transmitting, by the Node-B to the UE, an indication of the aggregate mean loading value via a second common control channel.

2. The method of claim 1, wherein the RoT level comprises an instantaneous RoT level.

3. The method of claim 1, wherein periodically transmitting the indication of the RoT level comprises transmitting the indication of the RoT level each transmission time interval (TTI).

4. The method of claim 1, wherein the first common control channel comprises a Fast Persistence Common Control Channel (FPCCH).

5. The method of claim 1, wherein the second common control channel comprises a secondary common control channel (S-CCPCH).

6. The method of claim 1, wherein the indication of the RoT level comprises an indication of whether the RoT level is above an upper threshold, below a lower threshold, or neither.

7. The method of claim 1, wherein the aggregate mean loading value comprises a slow persistence parameter.

8. The method of claim 1, wherein periodically determining the aggregate mean loading value comprises receiving, by the Node-B, indications of mean channel quality from multiple UE devices via an uplink control channel.

9. The method of claim 1, wherein periodically determining the aggregate mean loading value comprises determining the aggregate mean loading value using at least one type of metric from the group consisting of uplink channel quality, downlink channel quality, buffer occupancy, traffic model priority, and QoS.

10. A method for rate control signaling to facilitate user equipment (UE) uplink data transfer, the method comprising:
periodically receiving, by UE, a first load indicator via a first common control channel of a Node-B;
periodically receiving, by the UE, an indication of an aggregate mean loading value via a second common control channel of the Node-B;
determining, by the UE, a Modulation and Coding Scheme (MCS) level using the RoT level and the aggregate mean loading value;
transmitting, by the UE, uplink data at the MCS level.

11. The method of claim 10, wherein determining the MCS level comprises using at least some information from the group consisting of a RoT margin for the UE, an uplink channel quality of the UE, and buffered data of the UE.

12. The method of claim 10, wherein the MCS level comprises at least one transmission parameter from the group consisting of data rate, code rate, modulation, and power level.

13. The method of claim 10, further comprising determining a RoT margin for the UE.

14. The method of claim 13, wherein the RoT margin for the UE comprises an upper-bound of RoT that the UE can use transmitting.

15. The method of claim 13, wherein determining the RoT margin for the UE comprises using at least some information from the group consisting of the aggregate mean loading value, the first load indicator, soft handoff participation by the UE, a mean loading value for the UE.

16. The method of claim 10, further comprising transmitting, by the UE, an indication of a mean loading value for the UE.

17. The method of claim 16, wherein transmitting the mean loading value for the UE comprising determining the mean loading value for the UE using at least one type of metric from the group consisting of uplink channel quality, downlink channel quality, buffer occupancy, traffic model priority, and QoS.
